(19) United States
(12) Patent Application Publication
(10) Pub. No.: US 2019/0088202 A1
(43) Pub. Date: Mar. 21, 2019

(54) DISPLAY APPARATUS AND DRIVING METHOD THEREOF

(71) Applicants: HKC Corporation Limited, Shenzhen City, Guangdong (CN); Chongqing HKC Optoelectronics Technology Co., Ltd., Chongqing (CN)

(72) Inventors: Wenqin ZHAO, Chongqing (CN); Wei CHEN, Chongqing (CN)

(21) Appl. No.: 15/580,462

(22) PCT Filed: Oct. 20, 2017
(86) PCT No.: PCT/CN2017/107033

§ 371 Date: Dec. 7, 2017

(30) Foreign Application Priority Data
Sep. 15, 2017 (CN) 201710835070.2

(51) Int. Cl. G09G 3/3258

(52) U.S. Cl. CPC G09G 3/3258; G09G 2310/0264; G09G 2310/08

(57) ABSTRACT

This application provides a display apparatus and a driving method thereof. The display apparatus includes: a display panel; a timing control unit, providing a control signal, where the control signal includes a first potential and a second potential; and a voltage regulation module, electrically connected to the timing control unit and the display panel, where the voltage regulation module includes: a voltage generation unit, generating a standard voltage according to the control signal, so as to transmit the standard voltage to the display panel; a voltage analysis unit, individually analyzing a first voltage value and a second voltage value of the standard voltage when the control signal is of the first potential and second potential; and a voltage regulation unit, regulating the standard voltage generated by the voltage generation unit when determining that the first voltage value and the second voltage value meet a regulation condition.

### BACKGROUND

### Technical Field

This application relates to the field of display technologies, and in particular, to a display apparatus and a driving method thereof.

### Related Art

In a display, a system main board is connected to a Control Board (C-Board) through a line, the C-Board is connected to a printed circuit board (PCB) through, for example, a Flexible Flat Cable (FFC), and the PCB is further connected to a display region through a Source-Chip on Film (S-COF) and a Gate-Chip on Film (G-COF). A driving method of a display includes: transmitting, by a system main board, a color (for example: R/G/B) compressed signal, a control signal, and power to a C-Board. After being processed by a Timing Controller (TCON) on the C-Board, the signals are transmitted to a source circuit and a gate circuit of the PCB, and data and power of necessity are transmitted to a display region through the S-COF and the G-COF, so that the display obtains the power and signals required for presenting a screen.

However, display operation of a display is driven by a voltage. In a display process, the display needs to first generate a standard voltage VCOM. A standard voltage COM and a gamma reference voltage Gamma for a display purpose have a direct value correspondence in terms of voltage values of a highest voltage and a lowest voltage. In the related art, a reference voltage generation unit of a PCB generates a reference voltage VREF, the reference voltage VREF and a ground voltage GND are transmitted to a voltage regulation unit such as a Digital Voltage Regulator (DVR) or a mechanical Voltage Regulator (VR). According to a voltage division principle, the voltage regulation unit can perform regulation to obtain a required standard voltage VCOM and output the standard voltage VCOM to a display panel.

However, when a value relationship between the standard voltage COM and the gamma reference voltage Gamma for a display purpose is asymmetric, a flicker phenomenon may occur. There are usually two solutions to this problem:

(1) When being produced, panels are sampled, an optimal standard voltage VCOM_Y of sample panels is obtained by commissioning, and further, an optimal standard voltage VCOM of other display panels is considered to be the same as the optimal standard voltage VCOM_Y of the samples. A disadvantage of this solution is: because of unstable processing of display panels in a manufacturing process, there is a processing difference between different display panels, resulting in a difference between optimal standard voltages VCOM of different panels, and consequently, display panels having a difference therebetween have different optimal standard voltages VCOM, and the optimal standard voltages VCOM may not necessarily be the optimal standard voltage VCOM_Y, that is, a flicker phenomenon occurs.

(2) An optical sensor is added to a production line to detect flicker strength, and an optimal standard voltage VCOM of each display panel is commissioned by means of software, and when a flicker phenomenon is the least, an optimal standard voltage VCOM_Y of a display panel is considered to be obtained. Disadvantages of this solution are: relatively long working hours and inapplicability to products with separate PCBs (X board) and C-Boards (C board). Because the products with separate PCBs (X board) and C-Boards (C board) are usually partially delivered, when the products arrives at a client, an error in an optimal VCOM of a panel may still be caused.

Further, as a service time is extended, a working voltage of a relevant component is attenuated. In addition, because attenuation speeds of voltage signals of types, such as a standard VCOM and a gamma reference voltage Gamma, are inconsistent, after a display panel is used for a long time, the standard voltage VCOM deviates from an optimal voltage value. Therefore, value relationships between various voltages obtained by the display panel have deviations, further resulting in a degradation problem such as flickers.

### SUMMARY

To resolve the foregoing technical problems, an objective of this application is to provide a display apparatus and a driving method thereof, for alleviating problems, such as flickers, in presentation of a display panel by regulating a standard voltage.

The objective of this application is achieved and the technical problem of this application is resolved by using the following technical solutions. A display apparatus is provided according to this application, comprising: a display panel; a timing control unit, providing a control signal, where the control signal comprises a first potential and a second potential; and a voltage regulation module, electrically connected to the timing control unit and the display panel, where the voltage regulation module comprises: a voltage generation unit, generating a standard voltage according to the control signal, so as to transmit the standard voltage to the display panel; a voltage analysis unit, individually analyzing a first voltage value and a second voltage value of the standard voltage when the control signal is of the first potential and second potential; and a voltage regulation unit, regulating the standard voltage generated by the voltage generation unit when determining that the first voltage value and the second voltage value meet a regulation condition.

The technical problem of this application may be further resolved by taking the following technical measures.

In an embodiment of this application, the control signal is a frame synchronization signal, the first potential is a high potential, and the second potential is a low potential.

In an embodiment of this application, when obtaining the frame synchronization signal of the high potential, the voltage regulation module runs an active display power supply mode for the display panel, and when obtaining the frame synchronization signal of the low potential, the voltage regulation module runs a vertical blank power supply mode for the display panel.

In an embodiment of this application, the voltage regulation unit stores a voltage threshold, and when the regulation condition is that a deviation value between the first voltage value and the second voltage value meets a condition of the voltage threshold, the voltage regulation unit regulates the standard voltage.

In an embodiment of this application, during a period of regulating, by the voltage regulation unit, the standard voltage, when the deviation value is less than the voltage threshold, the voltage regulation unit stops regulating the standard voltage.

In an embodiment of this application, the voltage regulation unit continuously calculates deviation values, and obtains a minimum deviation value from the deviation values, and when the minimum deviation value is less than the voltage threshold, the voltage regulation unit stops regulating the standard voltage.

In an embodiment of this application, the voltage regulation unit obtains a plurality of first voltage values and a plurality of second voltage values, and obtains a maximum voltage value and a minimum voltage from the plurality of first voltage values and the plurality of second voltage values to calculate the deviation value.

In an embodiment of this application, when the voltage regulation unit regulates the standard voltage, the voltage regulation unit uses the standard voltage as a start and positively or negatively regulates a voltage value range.

A secondary objective of this application is to provide a driving method of a display apparatus, comprising: generating, by using a voltage generation unit, a standard voltage according to an obtained control signal, so as to transmit the standard voltage to a display panel; individually analyzing, by using a voltage analysis unit, a deviation value between a first voltage value and a second voltage value of the standard voltage respectively when the control signal is of the first potential and second potential; and when the deviation value exceeds the voltage threshold, regulating, by the voltage regulation unit, the standard voltage until the voltage analysis unit obtains a minimum deviation value from all deviation values, and the minimum deviation value is less than the voltage threshold.

Another objective of this application is to provide a display apparatus, comprising: a display panel; a timing control unit, providing a frame synchronization signal, where the frame synchronization signal comprises a high potential and a low potential; and a voltage regulation module, electrically connected to the timing control unit and the display panel, where when obtaining the frame synchronization signal of the high potential, the voltage regulation module runs an active display power supply mode for the display panel, when obtaining the frame synchronization signal of the low potential, the voltage regulation module runs a vertical blank power supply mode for the display panel, and the voltage regulation module comprises: a voltage generation unit, generating a standard voltage according to the frame synchronization signal, so as to transmit the standard voltage to the display panel; a voltage analysis unit, obtaining and analyzing a first voltage value of the standard voltage when the frame synchronization signal of the high potential is obtained, obtaining and analyzing a second voltage value of the standard voltage when the frame synchronization signal of the low potential is obtained, and obtaining a deviation value between the first voltage value and the second voltage value; and a voltage regulation unit, storing a voltage threshold, where when determining that the deviation value meets a condition of the voltage threshold, the voltage regulation unit regulates the standard voltage generated by the voltage generation unit.

This application can maintain original processing requirements and product costs without greatly changing an existing production process, and after a display apparatus is used for a long time, a standard voltage VCOM can still be maintained at a proper voltage value, and be maintained in a proper value correspondence with a gamma reference voltage, thereby resolving problems of flickers and unstable brightness of the display apparatus caused by deviation of the standard voltage from an optimal value. In addition, when being driven, the display apparatus can perform adaptive regulation on the standard voltage. Therefore, this application is applicable to driving circuits of various display apparatuses and is applicable to display and electronic product components delivered partially.

### BRIEF DESCRIPTION OF THE DRAWINGS

FIG. 1a is a schematic structural diagram of configuration of a driving circuit of an exemplary display apparatus.

FIG. 1b is a schematic diagram of a local structure of a driving circuit of an exemplary display apparatus;

FIG. 1c is a schematic diagram of presentation of display screen resolution of an exemplary display apparatus;

FIG. 2 is a schematic architectural diagram of a driving circuit for applying an embodiment to a display apparatus according to a method of this application;

FIG. 3 is a schematic architectural diagram of a driving circuit for applying an embodiment to a display apparatus according to a method of this application; and

FIG. 4 is a schematic diagram of a driving process for applying an embodiment to a display apparatus according to a method of this application.

### DETAILED DESCRIPTION

The following embodiments are described with reference to the accompanying drawings, and are used to exemplify particular embodiments for implementation of this application. Terms about directions mentioned in this application, such as “on”, “below”, “front”, “back”, “left”, “right”, “in”, “out”, and “side face”, merely refer to directions in the accompanying drawings. Therefore, the used terms about directions are used to describe and understand this application, and are not intended to limit this application.

The accompanying drawings and the description are considered to be essentially exemplary, rather than limitative. In the figures, units with similar structures are represented by using the same reference number. In addition, for understanding and ease of description, the size and the thickness of each component shown in the accompanying drawings are arbitrarily shown, but this application is not limited thereto.

In the accompanying drawings, for clarity, thicknesses of a layer, a film, a panel, an area, and the like are enlarged. In the accompanying drawings, for understanding and ease of description, thicknesses of some layers and areas are enlarged. It should be understood that when a component such as a layer, a film, an area, or a base is described to be “on” “another component”, the component may be directly on the another component, or there may be an intermediate component.

In addition, throughout this specification, unless otherwise explicitly described to have an opposite meaning, the word “include” is understood as including the component, but not excluding any other component. In addition, throughout this specification, “on” means that one is located above or below a target component and does not necessarily mean that one is located on the top based on a gravity direction.

To further describe the technical measures taken in this application to achieve the predetermined inventive objectives and effects thereof, specific implementations, structures, features, and effects of a display apparatus and a driving method thereof provided according to this application are described below in detail with reference to the accompanying drawings and preferred embodiments.

A display panel of this application may include a first substrate and a second substrate, and the first substrate and the second substrate may, for example, be a Thin Film Transistor (TFT) substrate and a Color Filter (CF) substrate. However, this application is not limited thereto. In some embodiments, alternatively, an active switch array and a CF in this application may be formed on a same substrate.

In some embodiments, the display panel of this application may, for example, be a liquid crystal display panel. However, this application is not limited thereto. Alternatively, the display panel may be an OLED display panel, a W-OLED display panel, a QLED display panel, a plasma display panel, a curved-surface display panel, or a display panel of another type.

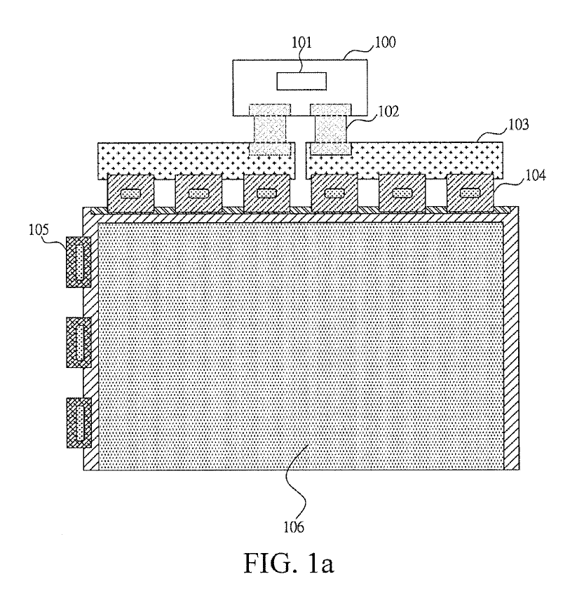

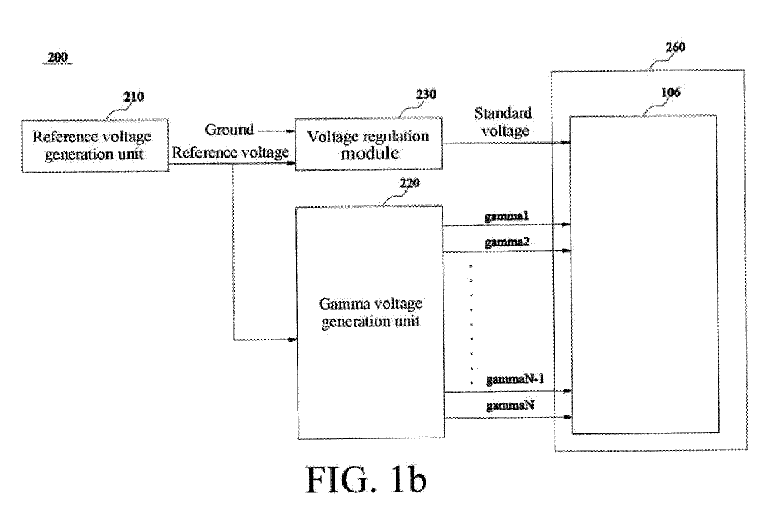

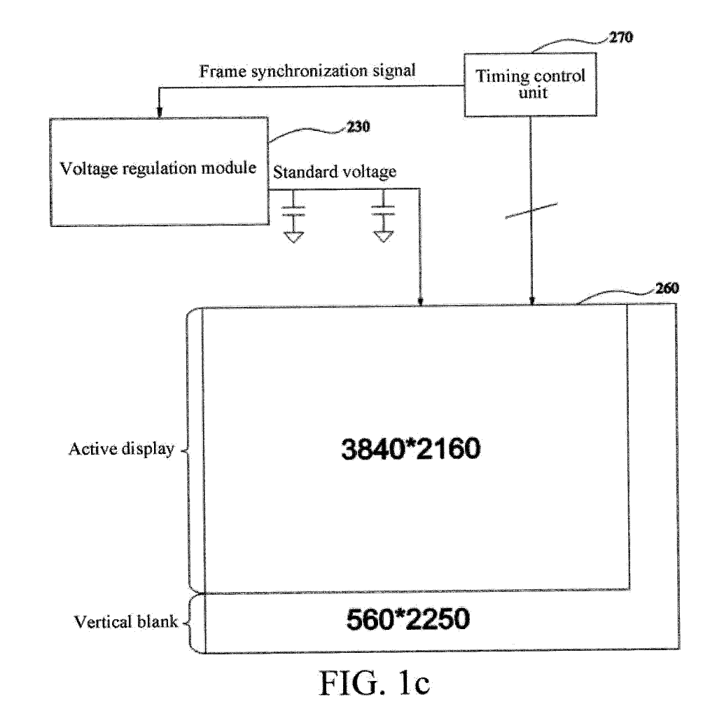

FIG. 1a is a schematic structural diagram of configuration of a driving circuit of an exemplary display apparatus, and FIG. 1b is a schematic diagram of a local structure of a driving circuit of an exemplary display apparatus. As shown in FIG. 1a, a driving method of a display apparatus includes: providing and transmitting, by a system main board, a color (for example: R/G/B) compressed signal, a control signal, and power to a C-Board 100. After being processed by a TCON 101 on the C-Board 100, the signals, together with the power processed by a display apparatus 200, are transmitted to a source circuit and a gate circuit of a PCB 103 through, for example, an FFC 102, and data and power of necessity are transmitted to a display region 106 through a S-COF 104 and a G-COF 105, so that a display obtains the power and signals required for presenting a screen.

As shown in FIG. 1b, the display apparatus 200 includes: a reference voltage generation unit 210, a gamma voltage generation unit 220, and a voltage regulation module 230. The reference voltage generation unit 210 provides a reference voltage Vref to the gamma voltage generation unit 220, and after the reference voltage Vref is converted by the gamma voltage generation unit 220, a plurality of gamma reference voltages gamma1, gamma2, gammaN−1, and gammaN is output (N is usually 18 or 14). The plurality of gamma reference voltages is separately provided to a display region 106 of a display panel, so as to drive each pixel circuit of the display panel using different gray level voltages.

In a display process, the display needs to first generate a standard voltage VCOM. Generally, a standard voltage COM and a gamma reference voltage for a display purpose have a direct value correspondence in terms of voltage values of a highest voltage (such as the foregoing gamma1) and a lowest voltage (such as the foregoing gammaN). In the related art, the reference voltage generation unit 210 generates a reference voltage VREF, the reference voltage VREF and a ground voltage GND are transmitted to the voltage regulation module 230 such as a DVR or a mechanical VR. According to a voltage division principle, the voltage regulation module 230 can perform regulation to obtain a required standard voltage VCOM and output the standard voltage VCOM to the display panel 106 of the display panel.

However, when a value relationship between the standard voltage COM and the gamma reference voltage Gamma for a display purpose is asymmetric, a flicker phenomenon may occur. In addition, because attenuation speeds of the standard voltage VCOM, the reference voltage VREF, and the gamma reference voltage (gamma) are inconsistent, after the display panel is used for a long time, the standard voltage VCOM gradually deviates from an optimal voltage value.

FIG. 1c is a schematic diagram of presentation of display screen resolution of an exemplary display apparatus. As shown in FIG. 1c, a timing control unit provides a frame synchronization signal STV to the voltage regulation module 230. Generally, the frame synchronization signal (STV) has a high potential and a low potential, used for distinguishing between an active display period (V-Active, V-Disp) for displaying a video and a vertical blank period (V-Blank) for not displaying a video of the display panel. The active display period for displaying a video depends on the display region (a number of rows of effective pixels) of the display panel. The vertical blank period is a period used for signal processing, and therefore, is unnecessarily fixed and may differ because of, for example, a manufacturing scheme and structural design. As shown in FIG. 1c, when the frame synchronization signal is of a high potential, running among relevant components, such as the timing control unit, the voltage regulation module, and the display panel, enters a V-Active running mode; correspondingly, when the frame synchronization signal is of a low potential, running among relevant components, such as the timing control unit, the voltage regulation module, and the display panel, enters a V-Blank running mode. As shown in FIG. 1c, using resolution of 4K display (UHD) as an example, a V-Active region and a V-Blank region are obviously distinguished. When an active display region is scanned, a data line is electrically coupled to a standard voltage line in the display panel. When a vertical blank region is scanned, the data line is not electrically coupled to the standard voltage line in the display panel. In this case, different scanned regions may cause an asymmetric value relationship between the standard voltage and the gamma reference voltage Gamma for a display purpose, and a severer standard voltage deviation.

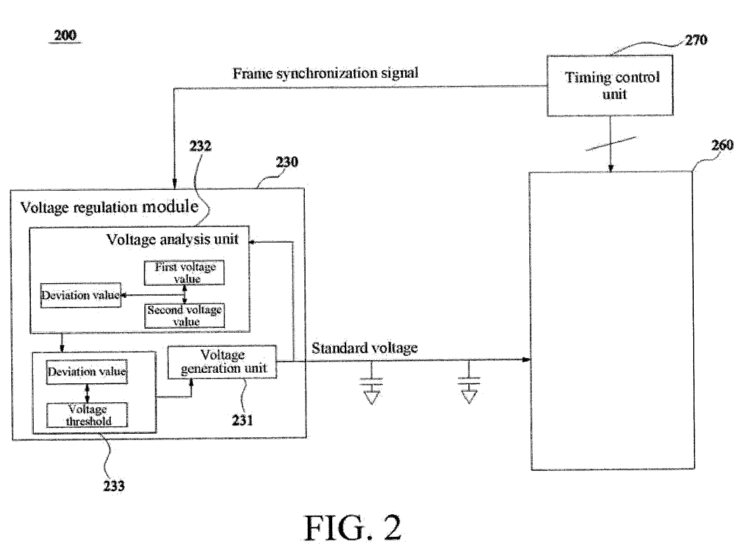

FIG. 2 is a schematic architectural diagram of a driving circuit for applying an embodiment to a display apparatus according to a method of this application. In an embodiment of this application, a display apparatus 200 is provided, including: a display panel 260; a timing control unit 270, providing a control signal, where the control signal includes a first potential and a second potential; and a voltage regulation module 230, electrically connected to the timing control unit 270 and the display panel 260, where the voltage regulation module 230 includes: a voltage generation unit 231, generating a standard voltage VCOM according to the control signal, so as to transmit the standard voltage VCOM to the display panel 260; a voltage analysis unit 232, individually analyzing a first voltage value VCOMa and a second voltage value VCOMb of the standard voltage VCOM when the control signal is of the first potential and second potential; and a voltage regulation unit 233, regulating the standard voltage VCOM generated by the voltage generation unit 231 when determining that the first voltage value VCOMa and the second voltage value VCOMb meet a regulation condition.

In embodiments, the control signal is a frame synchronization signal STV, the first potential is a high potential STV_H, and the second potential is a low potential STV_L.

In embodiments, when obtaining the frame synchronization signal STV_H of the high potential, the voltage regulation module 230 runs an active display power supply mode for the display panel 260, and when obtaining the frame synchronization signal (STV_L) of the low potential, the voltage regulation module 230 runs a vertical blank power supply mode for the display panel. In some embodiments, the active display means an active display period (V-Active, V-Disp) for displaying a video, and the vertical blank means a vertical blank period (V-Blank) for not displaying a video of the display panel. When an active display region is scanned, a data line is electrically coupled to a standard voltage line in the display panel 260. When a vertical blank region is scanned, the data line is not electrically coupled to the standard voltage line in the display panel 260.

In embodiments, the voltage regulation unit 233 stores a voltage threshold Vth, and when the regulation condition is that a deviation value |VCOMa−VCOMb| between the first voltage value VCOMa and the second voltage value VCOMb meets a condition of the voltage threshold Vth, the voltage regulation unit 233 regulates the standard voltage VCOM.

In some embodiments, the voltage threshold Vth is preset in an execution parameter or a program of the voltage regulation module 230 or an execution parameter or a program of the voltage regulation unit 233, or is stored in a storage unit (not shown in the figure) of the display panel 260 for being read and used by the voltage regulation module 230.

In some embodiments, during a period of regulating, by the voltage regulation unit 233, the standard voltage VCOM, when the deviation value |VCOMa−VCOMb| is less than the voltage threshold Vth, the voltage regulation unit 233 stops regulating the standard voltage VCOM.

In embodiments, the voltage regulation unit 233 continuously calculates deviation values |VCOMa−VCOMb|, and obtains a minimum deviation value from the deviation values |VCOMa−VCOMb|, and when the minimum deviation value is less than the voltage threshold Vth, the voltage regulation unit 233 stops regulating the standard voltage VCOM.

In embodiments, the voltage regulation unit 233 obtains a plurality of first voltage values VCOMa and a plurality of second voltage values VCOMb, and obtains a maximum voltage value VCOM(max) and a minimum voltage VCOM(min) from the plurality of first voltage values VCOMa and the plurality of second voltage values VCOMb to calculate the deviation value.

In some embodiments, when the voltage regulation unit 233 regulates the standard voltage VCOM, the voltage regulation unit 230 uses the standard voltage VCOM as a start and positively or negatively regulates a voltage value range VCOM_add, that is, a range of VCOM+VCOM_add to VCOM−VCOM_add.

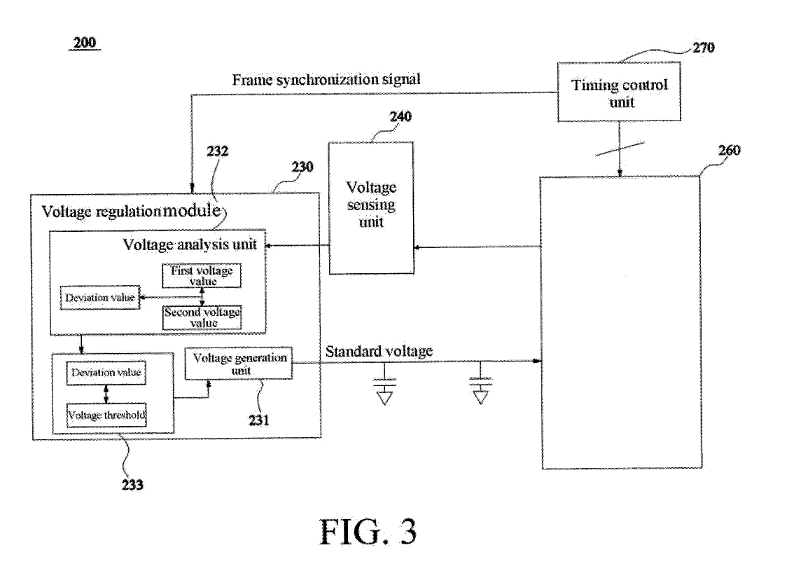

FIG. 3 is a schematic architectural diagram of a driving circuit for applying an embodiment to a display apparatus according to a method of this application.

In some embodiments, a voltage sensing unit 240 is disposed between the voltage regulation module 230 and the display panel 260. The voltage sensing unit 240 continuously senses standard voltages VCOM of a standard voltage line on the display panel 260 or standard voltages VCOM at an output interface of the voltage regulation module 230, obtains the first voltage value VCOMa and the second voltage value VCOMb in different running states, and further provides them to the voltage regulation module 230.

In some embodiments, the voltage regulation module 230 is a DVR or a mechanical VR.

In some embodiments, when the voltage regulation unit 230 is a DVR, an analog/digital signal converter (not shown in the figure) is disposed between the voltage regulation module 230 and the display panel 260 or at the output interface of the voltage regulation module 230, so as to convert the standard voltage VCOM into a digital signal.

In an embodiment of this application, a driving circuit included by a display apparatus of this application may be any one in the foregoing embodiment.

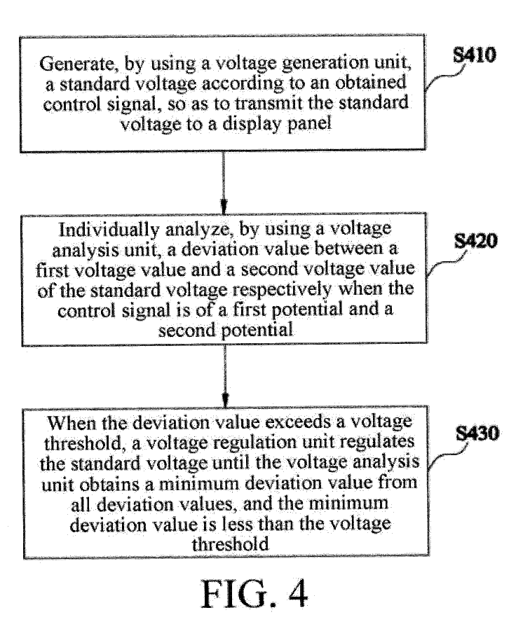

FIG. 4 is a schematic diagram of a driving process for applying an embodiment to a display apparatus according to a method of this application. In an embodiment of this application, a driving method of this application is provided, including:

Step S410: Generate, by using a voltage generation unit 231, a standard voltage VCOM according to an obtained control signal, so as to transmit the standard voltage VCOM to a display panel 260.

Step S420: Individually analyze, by using a voltage analysis unit 232, a deviation value between a first voltage value and a second voltage value of the standard voltage respectively when the control signal is of the first potential and second potential.

Step S430: When the deviation value exceeds the voltage threshold Vth, the voltage regulation unit 233 regulates the standard voltage VCOM until the voltage analysis unit 232 obtains a minimum deviation value from all deviation values, and the minimum deviation value is less than the voltage threshold.

In an embodiment of this application, a display apparatus 200 of this application is provided, including: a display panel 260; a timing control unit 270, providing a frame synchronization signal, where the frame synchronization signal includes a high potential and a low potential; and a voltage regulation module 230, electrically connected to the timing control unit 270 and the display panel 260, where when obtaining the frame synchronization signal STL_H of the high potential, the voltage regulation module 230 runs an active display (V-Active) power supply mode for the display panel 260, when obtaining the frame synchronization signal STV_L of the low potential, the voltage regulation module 230 runs a vertical blank (V_Blank) power supply mode for the display panel 260, and the voltage regulation module 230 includes: a voltage generation unit 231, generating a standard voltage VCOM according to the frame synchronization signal STL, so as to transmit the standard voltage VCOM to the display panel 260; a voltage analysis unit 232, obtaining and analyzing a first voltage value VCOMa of the standard voltage VCOM when the frame synchronization signal STL_H of the high potential is obtained, obtaining and analyzing a second voltage value VCOMb of the standard voltage VCOM when the frame synchronization signal STV_L of the low potential is obtained, and obtaining a deviation value |VCOMa−VCOMb| between the first voltage value VCOMa and the second voltage value VCOMb; and a voltage regulation unit 233, storing a voltage threshold Vth, where when determining that the deviation value |VCOMa−VCOMb| meets a condition of the voltage threshold Vth, the voltage regulation unit 233 regulates the standard voltage VCOM generated by the voltage generation unit 231.

This application can maintain original processing requirements and product costs without greatly changing an existing production process, and after a display apparatus is used for a long time, a standard voltage VCOM can still be maintained at a proper voltage value, and be maintained in a proper value correspondence with a gamma reference voltage, thereby resolving problems of flickers and unstable brightness of the display apparatus caused by deviation of the standard voltage from an optimal value.

The wordings such as “in some embodiments” and “in various embodiments” are repeatedly used. The wordings usually refer to different embodiments, but they may also refer to a same embodiment. The words, such as “comprise”, “have”, and “include”, are synonyms, unless other meanings are indicated in the context thereof.

Descriptions above are merely preferred embodiments of this application, and are not intended to limit this application. Although this application has been disclosed above in forms of preferred embodiments, the embodiments are not intended to limit this application. A person skilled in the art can make some equivalent variations, alterations or modifications to the above disclosed technical content without departing from the scope of the technical solutions of the above disclosed technical content to obtain equivalent embodiments. Any simple alteration, equivalent change or modification made to the foregoing embodiments according to the technical essence of this application without departing from the content of the technical solutions of this application shall fall within the scope of the technical solutions of this application.

What is claimed is:

1. A display apparatus, comprising:
a display panel;
a timing control unit, providing a control signal, wherein the control signal comprises a first potential and a second potential; and
a voltage regulation module, electrically connected to the timing control unit and the display panel, wherein the voltage regulation module comprises:
a voltage generation unit, generating a standard voltage according to the control signal, so as to transmit the standard voltage to the display panel;
a voltage analysis unit, individually analyzing a first voltage value and a second voltage value of the standard voltage when the control signal is of the first potential and second potential; and
a voltage regulation unit, regulating the standard voltage generated by the voltage generation unit when determining that the first voltage value and the second voltage value meet a regulation condition.

2. The display apparatus according to claim 1, wherein the control signal is a frame synchronization signal.

3. The display apparatus according to claim 2, wherein the first potential is a high potential, and the second potential is a low potential.

4. The display apparatus according to claim 3, wherein when obtaining the frame synchronization signal of the high potential, the voltage regulation module runs an active display power supply mode for the display panel.

5. The display apparatus according to claim 3, wherein when obtaining the frame synchronization signal of the low potential, the voltage regulation module runs a vertical blank power supply mode for the display panel.

6. The display apparatus according to claim 1, wherein the voltage regulation unit stores a voltage threshold.

7. The display apparatus according to claim 6, wherein when the regulation condition is that a deviation value between the first voltage value and the second voltage value meets a condition of the voltage threshold, the voltage regulation unit regulates the standard voltage.

8. The display apparatus according to claim 7, wherein during a period of regulating, by the voltage regulation unit, the standard voltage, when the deviation value is less than the voltage threshold, the voltage regulation unit stops regulating the standard voltage.

9. The display apparatus according to claim 8, wherein the voltage regulation unit continuously calculates deviation values, and obtains a minimum deviation value from the deviation values.

10. The display apparatus according to claim 9, wherein when the minimum deviation value is less than the voltage threshold, the voltage regulation unit stops regulating the standard voltage.

11. The display apparatus according to claim 8, wherein the voltage regulation unit obtains a plurality of first voltage values and a plurality of second voltage values, and obtains a maximum voltage value and a minimum voltage from the plurality of first voltage values and the plurality of second voltage values to calculate the deviation value.

12. The display apparatus according to claim 1, wherein when the voltage regulation unit regulates the standard voltage, the voltage regulation unit uses the standard voltage as a start and positively regulates a voltage value range.

13. The display apparatus according to claim 1, wherein when the voltage regulation unit regulates the standard voltage, the voltage regulation unit uses the standard voltage as a start and negatively regulates a voltage value range.

14. A driving method of a display apparatus, comprising:
generating, by using a voltage generation unit, a standard voltage according to an obtained control signal, so as to transmit the standard voltage to a display panel;
individually analyzing, by using a voltage analysis unit, a deviation value between a first voltage value and a second voltage value of the standard voltage respectively when the control signal is of the first potential and second potential; and
when the deviation value exceeds a voltage threshold, regulating, by a voltage regulation unit, the standard voltage until the voltage analysis unit obtains a minimum deviation value from all deviation values, and the minimum deviation value is less than the voltage threshold.

15. The driving method of a display apparatus according to claim 14, wherein the control signal is a frame synchronization signal.

16. The driving method of a display apparatus according to claim 14, wherein the first potential is a high potential, and the second potential is a low potential.

17. The driving method of a display apparatus according to claim 14, wherein the voltage regulation unit stores a voltage threshold.

18. The driving method of a display apparatus according to claim 14, wherein when the voltage regulation unit regulates the standard voltage, the voltage regulation unit uses the standard voltage as a start and positively regulates a voltage value range.

19. The driving method of a display apparatus according to claim 14, wherein when the voltage regulation unit regulates the standard voltage, the voltage regulation unit uses the standard voltage as a start and negatively regulates a voltage value range.

20. A display apparatus, comprising:
a display panel;
a timing control unit, providing a frame synchronization signal, wherein the frame synchronization signal comprises a high potential and a low potential; and
a voltage regulation module, electrically connected to the timing control unit and the display panel, wherein when obtaining the frame synchronization signal of the high potential, the voltage regulation module runs an active display power supply mode for the display panel, when obtaining the frame synchronization signal of the low potential, the voltage regulation module runs a vertical blank power supply mode for the display panel, and the voltage regulation module comprises:
a voltage generation unit, generating a standard voltage according to the frame synchronization signal, so as to transmit the standard voltage to the display panel;
a voltage analysis unit, obtaining and analyzing a first voltage value of the standard voltage when the frame synchronization signal of the high potential is obtained, obtaining and analyzing a second voltage value of the standard voltage when the frame synchronization signal of the low potential is obtained, and obtaining a deviation value between the first voltage value and the second voltage value; and
a voltage regulation unit, storing a voltage threshold, wherein when determining that the deviation value meets a condition of the voltage threshold, the voltage regulation unit regulates the standard voltage generated by the voltage generation unit.
